(19) United States
(12) Patent Application Publication
(10) Pub. No.: US 2009/0178929 A1
(43) Pub. Date: Jul. 16, 2009

(54) SEPARATION DEVICE FOR ISOELECTRIC FOCUSING

(75) Inventors: Dirk Jan Broer, Geldrop (NL); Emiel Peeters, Eindhoven (NL); Ralph Kurt, Eindhoven (NL); Roel Penterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/302,923

(22) PCT Filed: May 22, 2007
(86) PCT No.: PCT/IB2007/051929

§ 371 Date: Dec. 1, 2008

(30) Foreign Application Priority Data
Jun. 2, 2006 (EP) 06114898.7

(51) Int. Cl. B01D 57/00; C40B 60/00

(52) U.S. Cl. 204/644; 506/33

(57) ABSTRACT

The invention relates to a device for use in separation, especially isoelectric focusing employing “pH sink regions”, whereby the direction of change in pH is reversed.

The present invention is directed to the field of devices for separation, especially isoelectric focussing of biomolecules.

In the separation of biomolecules, especially of samples which may contain a multitude of biomolecules, techniques which are known as isoelectric focusing are widely used. In this separation technique it is used that many biomolecules such as proteins have a defined pH at which they are electrically neutral whereas below and above this pH they are charged.

Usually the isoelectric focusing is done in devices which have a continuously changing pH, although devices in which the pH is changed stepwise have been proposed, e.g. in the WO 2004/036204 A2 and US 20050150769 which are incorporated by reference.

However, especially for separation devices which are designed to provide a more automated separation there is the need that the position which the biomolecules will have after separation should be defined in order to ease an automatic reading of the separated sample.

It is therefore an object of the present invention to provide a device for separation, especially a separation device for isoelectric focussing in which for most applications a more automated separation and reading of the separated sample can be achieved.

This object is solved by a device according to claim 1 of the present invention. Accordingly, a device for use in separation, especially isoelectric focusing is proposed comprising a multitude of regions which are provided adjacent to each other along a separation direction, whereby the device comprises at least a pH sink region where the pH value is constant or has a curve with a slope different in sign compared to at least one adjacent region at which the pH value is increasing or decreasing.

It should be noted that in the sense of the present invention, the term “separation” is to be understood in its broadest sense and means and/or includes especially one or more of the following:
A process used for separating mixtures by virtue of differences in absorbency
A process in which a chemical mixture carried by a liquid or gas is separated into components as a result of differential distribution of the solutes as they flow around or over a stationary liquid or solid phase
any of a diverse group of techniques used to separate mixtures of substances based on differences in the relative affinities of the substances for two different media, one (the mobile phase) a moving fluid and the other (the stationary phase or sorbent) a porous solid and/or gel and/or a liquid coated on a solid support
separation techniques which result of different charges and/or masses under the influence of an external force, especially an external field and/or pH, such as e.g. isoelectrical focusing

It should be noted that the device according to the present invention may be of use—but not limited to—for separation of biological molecular compounds such as, but not limited to, nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, peptides, monoclonal or polyclonal antibodies, soluble or bound receptors, transcription factors, and the like), antigens, ligands, haptens, carbohydrates and related compounds (e.g. polysaccharides, oligosaccharides and the like), cellular fragments such as membrane fragments, cellular organelles, intact cells, bacteria, viruses, protozoa, and the like.

By using such a device, for most applications at least one of the following advantages can be achieved:
Due to providement of a pH sink region, the biomolecules will essentially not appear in this pH sink region. This allows a better automatization since then the regions in the device, especially in the separation area of the device where biomolecules may be present after conducting the separation are defined which in most applications easens the automatization of the analysis
The device can for this reason better be implemented in automated analysis devices which e.g. can be applied on a chip for high-screening and high-throughput analysis
As there are well defined regions (the pH sink regions) in which substantially no biomolecules will appear, the device allows a very efficient way of handling of all biomolecules, e.g. allowing to separate almost 100% of the initial analyte material in separation channels for further analysis or to allow very efficient analysis, as the pH sink regions allow to match the individual sensor elements to the separation regions (and align the pH sink regions with the less sensitive areas of the sensor i.e. the region between the individual sensor elements)
Biomolecules with an isoelectric focus point even very close together can for a wide range of applications within the present invention be efficiently separated (in a single step device) without of with only insignificant loss of analyte material
A device of the present invention is applicable in a wide range of applications especially of use for 2D-separation techniques
A device of the present invention allows in a wide range of applications to make very efficient clinical diagnosis tools, which are fast and reliable even for a very little amount of analyte. In such applications the analyte volume is often limited (for instance a blood sample of a patient). Moreover analysis time is an essential key parameter. Even very small amounts of dedicated proteins (or other molecules e.g. marking a certain pathogen) have to be detected
A device of the present invention allows in a wide range of applications to perform quantitative analysis in a single run.

According to a preferred embodiment of the present invention, the device comprises a multitude of pH-sink regions.

According to a preferred embodiment of the present invention, the device comprises a sequence of regions whereby a ph-sink region is followed by a separation region, whereby a separation region especially means and/or includes a region in which after the separation biomolecules may be present.

It should be noted that according to most applications within the present invention, the slope of the pH in the separation region(s) will be different in sign as in the pH sink region(s).

According to a different preferred embodiment of the present invention, the device comprises a sequence of regions whereby a pH-sink region is followed by a transition region which is then followed by a separation region, whereby a transition region in the sense of the present invention especially means and/or includes a region which is provided in separation direction immediately after a pH-sink region and which is upon separation essentially free of analytes.

It should be noted that in such a transition region the slope of the pH may be different in sign as in the pH sink region (although this must not be necessarily so); however, the introduction of such a transition region has been shown within a wide range of applications within the present invention to further increase the quality of the separation for a wide range of applications within the present invention since then the length of the pH sink region can be reduced.

In most applications within the present invention, the slope of the pH in the transition region will be different in sign as in the pH sink region in case such a transition region is present.

According to a preferred embodiment of the present invention, the length of the pH sink region is ≧2% and ≦200% of the average of the two adjacent separation regions. This allows for most applications within the present invention a compact design.

It should be noted that the term “adjacent” does not necessarily mean that the pH-sink regions is directly adjacent between two separation regions as there may be also a transition region between a pH-sink region and a separation region, as described above.

According to a preferred embodiment of the present invention, the length of the pH sink region is ≧5% and ≦100% of the average of the two adjacent separation regions.

According to a preferred embodiment of the present invention, the length of the pH sink region is ≧10% and ≦50% of the average of the two adjacent separation regions.

According to a preferred embodiment of the present invention, the length of the pH sink region (in the direction of the biomolecule flow during isoelectric focusing) is ≧1 μm and ≦500 μm. This allows for most applications within the present invention a compact design.

According to a preferred embodiment of the present invention, the length of the pH sink region is ≦100 μm.

According to a preferred embodiment of the present invention, the length of the pH sink region is ≦50 μm.

It should be noted that according to a preferred embodiment of the present invention, in case that several pH sink regions are present in the device the length of the pH sink regions may be equal or essentially equal, according to another preferred embodiment, the length of the pH sink regions are different from each other.

It should be noted that according to a preferred embodiment of the present invention, the length of the separation regions may be equal or essentially equal, according to another preferred embodiment, the length of the separation regions are different from each other.

According to a preferred embodiment the difference in pH (highest minus lowest pH increasing or decreasing gradient) in each single separation region is ≧0.05 and ≦4.0.

According to a preferred embodiment the difference in pH (increasing or decreasing gradient) in each single separation region is ≧0.1 and ≦2.0.

According to a preferred embodiment the difference in pH (increasing or decreasing gradient) in each single separation region is ≧0.1 and ≦1.0.

According to a preferred embodiment of the present invention, the average difference in pH in the separation regions is equal or essentially equal for all separation regions, whereas according to another preferred embodiment of the present invention, the average difference in pH in the separation regions is different for different separation regions.

According to a preferred embodiment of the present invention, the average difference in pH in the pH sink regions is equal or essentially equal for all pH sink regions, whereas according to another preferred embodiment of the present invention, the average difference in pH in the pH sink regions is different for different pH sink regions.

According to a preferred embodiment of the present invention, the device comprises at least a starting region which is provided (in terms of the separation direction) prior to both the pH sink region(s) and the separation region(s).

It has been shown in practice that such a starting region may improve the quality of the separation.

According to an preferred embodiment of the present invention, after the separation the pH sink regions are essentially free of analytes.

The term “essentially” means and/or includes less than 3 wt %, preferably less than 1 wt %, more preferable less than 0.1 wt % of all analytes in the sample.

According to a preferred embodiment of the present invention, number of adjacent separation regions with increasing (or decreasing) pH with pH sink region positioned within between two adjacent separation regions is ≧2 and ≦100.

This allows for a wild range of applications to perform analysis in a single run.

According to a preferred embodiment of the present invention, number of adjacent separation regions with increasing (or decreasing) pH with pH sink region positioned within between two adjacent separation regions is ≧20.

According to a preferred embodiment of the present invention, number of adjacent separation regions with increasing (or decreasing) pH with pH sink region positioned within between two adjacent separation regions is ≧50.

According to a preferred embodiment of the present invention, the regions are provided within a substrate material comprising a polyacrylicmaterial made out of the polymerization of at least one bifunctional monomer and at least one polyfunctional (f>2) monomer.

The monomers are according to an embodiment selected from a range such that the polymers formed thereof easily takes up water to form a swollen medium.

According to an embodiment of the present invention, the acrylic monomer is chosen out of the group comprising acrylamide, especially isopropylacrylamide, N, N dimethyl acrylamide, acrylic acid, hydroxyethylacrylate, ethoxyethoxyethylacrylate, methacrylic acid or mixtures thereof.

According to an embodiment of the present invention, the polyfunctional acrylic monomer is a bis-acryl and/or a tri-acryl and/or a tetra-acryl and/or a penta-acryl monomer.

According to an embodiment of the present invention, the polyfunctional monomer is chosen out of the group comprising N,N methylenebisacrylamide, diethyleneglycol diacrylate, triethyleneglycol diacrylate, tetraethyleneglycol diacrylate, polyethyleneglycol diacrylate, diethyleneglycol dimethacrylate, triethyleneglycol dimethacrylate, tetraethyleneglycol dimethacrylate etc. tripropyleneglycol diacrylates, pentaerythritol triacrylate or mixtures thereof.

According to a preferred embodiment of the present invention, the polyfunctional acrylic monomer mixture comprises at least one pH setting monomer.

According to a preferred embodiment of the present invention, the at least one pH setting monomer is chosen out of the group acrylic acid, acrylic amino derivatives of buffer moieties or mixtures thereof. These materials have been shown in practice to best suitable for a wide range of applications within the present invention.

According to a preferred embodiment of the present invention, the device comprises at least one pH setting layer in order to adjust the pH in the pH sink region(s) and separation regions.

According to a preferred embodiment of the present invention, the pH setting layer comprises a material chosen out of the group polymerized organic acids (such as acrylic acids or acrylic sulfonic acids), polymerized organic amines, pyridines or mixtures thereof. These materials have been shown in practice to be best suitable for a wide range of applications within the present invention.

According to a preferred embodiment of the present invention, the regions are provided within a substrate material comprising a polycarbohydrate material, especially comprising a polymer of 3,6-Anhydrogalactose and D-galactose.

According to a preferred embodiment of the present invention, the device furthermore comprises an automated analyzer and a multitude of pH sink regions, whereby the width of the pH sink regions and/or separation regions are adapted to the shape of automated analyzer.

According to a preferred embodiment of the present invention, the automated analyzer is a CCD camera. The CCD camera is a sensor for recording images, consisting of an integrated circuit containing an array of linked, or coupled, capacitors (pixels). Under the control of an external circuit, each capacitor can transfer its electric charge to one or other of its neighbours ultimately providing information on the light intensity that initially charged each pixel. The array of capacitors forms a matrix of for instance 1280×1024 pixels organized in a period ph for the horizontal rows and pv for the vertical columns.

According to a preferred embodiment of the present invention, the automated analyzer comprises at least one sensor selected out of the group of optical sensors, magnetic sensors, electrical sensors, capacitive sensors. In a wide range of applications, these sensors have proven itself in practice.

According to a preferred embodiment of the present invention, the width of the pH-sink region(s) and/or separation regions are matched to a separation medium which includes separation channels and/or separation directions.

Such a separation medium is e.g. disclosed in the EP 05111940, which is hereby incorporated by reference.

The present invention furthermore relates to a method of producing the separation regions, the pH-sink regions and/or the transition regions, comprising the steps of
a) providing a first separation zone with a gradually increasing and/or decreasing pH
b) introducing the pH sink regions and/or transition regions within the separation zone by adding a pH-setting means, especially to achieve a pH-setting layer

According to a preferred embodiment of the present invention, the separation zone is provided by selecting two buffers, especially acrylamido buffers dissolved in acryl amide, preferably with methylene-bisacrylamide as crosslinker and continuously changing the ratio between the buffers along the separation zone.

Preferably the separation zone is manufactured in that way that a gradient of acrylamido buffers in an acrylamide solution is cast into a slab gel that is crosslinked to a plastic support film, the gel, which forms the separation zone is washed to remove polymerization byproducts and after that the gel is dried for storage. The pH at any point in the separation zone may be determined by the mixture of buffers crosslinked into the gel at that site.

According to a preferred embodiment, step b) is provided by printing, preferably ink-jet printing an acidic and/or basic molecule onto selected parts of the separation zone, preferably in form of stripes.

According to another preferred embodiment, step b) is provided by first incorporating photo acid generators in the separation zone and then introducing the pH sink regions and/or transition regions by illumination of the separation zone through a grey scale mask, which causes a change of pH in the regions, where the mask is permeable.

The present invention furthermore relates to a method of producing the separation regions, the pH-sink regions and/or the transition regions, comprising selecting two buffers, especially acrylamido buffers dissolved in acryl amide, preferably with methylene-bisacrylamide as crosslinker and continuously changing the ratio between the buffers to create separation, pH-sink and/or transition regions.

This avoids the step b) in the method described further above and is therefore of use within a wide range of applications within the present invention; however, it has been shown that this method is more advantageous to provide a more smooth slope in the pH-gradient, whereas the above method is more of use for introducing a steeper slope in pH.

A device according to the present invention may be of use in a broad variety of systems and/or applications, amongst them one or more of the following:
biosensors used for molecular diagnostics
rapid and sensitive detection of proteins and nucleic acids in complex biological mixtures such as e.g. blood or saliva
high throughput screening devices for chemistry, pharmaceuticals or molecular biology
testing devices e.g. for DNA or proteins e.g. in criminology, for on-site testing (in a hospital), for diagnostics in centralized laboratories or in scientific research
tools for DNA or protein diagnostics for cardiology, infectious disease and oncology, food, and environmental diagnostics
tools for combinatorial chemistry
analysis devices

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several preferred embodiments of a separation medium as well as a device according to the invention.

FIG. 1 shows a very schematic top-view of a separation area of a device according to a first embodiment of the present invention;

FIG. 2 shows a very schematic top-view of a separation area of a device according to a second embodiment of the present invention;

FIG. 3 shows a very schematic diagram of the pH-gradient along the separation direction according to a third embodiment of the present invention;

FIG. 4 shows a very schematic diagram of the pH-gradient along the separation direction according to a fourth embodiment of the present invention; and

FIG. 5 shows a very schematic diagram of the pH-gradient along the separation direction according to a fifth embodiment of the present invention.

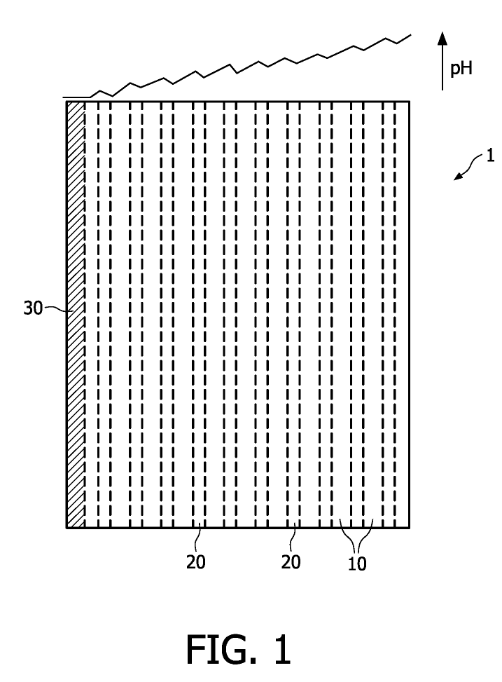

FIG. 1 shows a very schematic top-view of a separation area of a device 1 according to a first embodiment of the present invention. In this separation area separation regions 10 and pH-sink regions 20 are alternately lined up along the separation direction (which is in FIG. 1 from left to right). As is schematically indicated by the “pH”-curve, the pH is increasing in the separation regions 10, whereas in the pH-sink regions 20 it is decreasing.

The device 1 furthermore comprises a starting region 30 where the sample is injected prior to the separation.

As a consequence, after performing a separation, no biomolecule will be present in the pH sink regions 20, but only in the separation regions 10.

It should be noted that in FIG. 1 the width of the pH-sink regions 20 and the separation regions 10 are somewhat similar; however, in most applications the situation will be different with width the pH sink regions 20 being much smaller compared to the width of the separation regions 10.

It should be further noticed that in FIG. 1 some pH values may occur “double” or even multiple in the separation area of the device 1. However, a skilled person in the art will easily see that this is no problem since due to the fact that there is a separation direction there is for each pH only one position where the biomolecule will “end up”.

In order to enhance the quality of the separation it should be noted that especially when the separation technique is isoelectrical focusing, an external electrical field (not shown in the Figs.) may be applied.

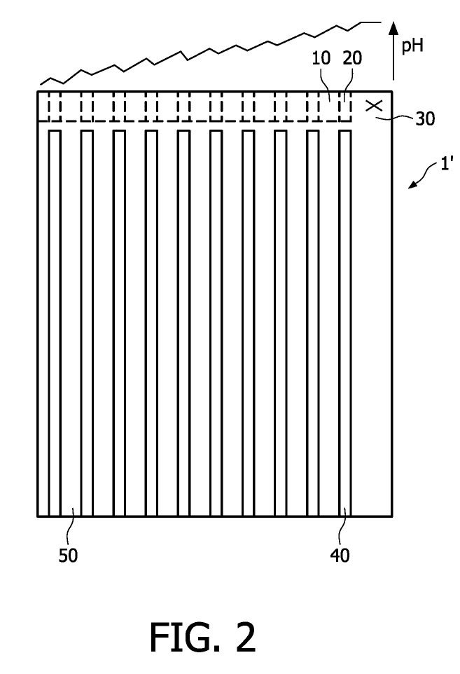

FIG. 2 shows a very schematic top-view of a separation area of a device 1′ according to a first embodiment of the present invention. This device is suitable for 2D separation and comprises separation regions 10 and pH-sink regions, which are adapted to walls 40 and channels 50 in between. This structure is e.g. known from the EP 05111940, which is hereby incorporated by reference.

The sample is in this embodiment injected in the starting region 30 (marked with an “X”). After that, a first separation on pH, e.g. isoelectrical focusing is performed, whereby the separation direction in this embodiment is from right to left, i.e. contrary to the device of FIG. 1.

As a consequence, all analytes in the sample will lay before a channel, since the separation regions 10 are adapted to the walls 40. In the second step of the separation (which e.g. maybe an SDS-PAGE), the analytes may only move inside the channels 50, which allows for a wide range of application with a much higher degree of separation.

It should furthermore be noted that according to another preferred embodiment (not shown in the Figs.) the channels may have a “well”-like structure. A structure like this is e.g. disclosed in the EP 05111940 and allows for a wide range of applications within the present invention a great degree of readability with an optical and/or mechanical sensor.

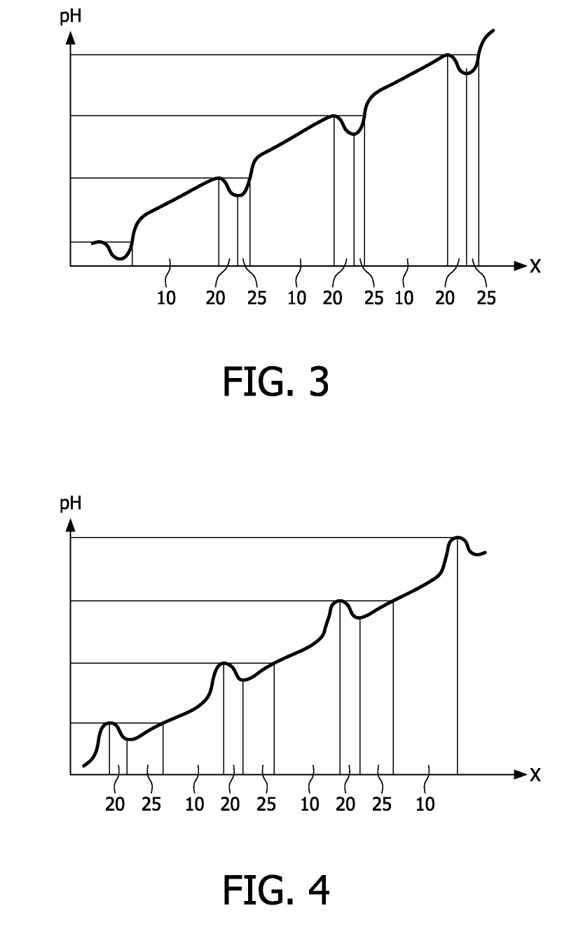

FIG. 3 shows a very schematic diagram of the pH-gradient along the separation direction (which is indicated with an “x”) according to a third embodiment of the present invention.

In FIG. 3, it can be clearly seen that along the separation direction, which is from left to right, there are consecutively provided a separation region 10, a pH-sink region 20 and a transition region 25, after that the next separation region 10 follows.

It should be noted that in FIG. 3, although the length of the pH-sink region compared to the separation region is rather short, due to the fact that there is the transition region 25, the ratio of the length of the regions where no or essentially no biomolecules are present to the length of the separation regions is around 20%.

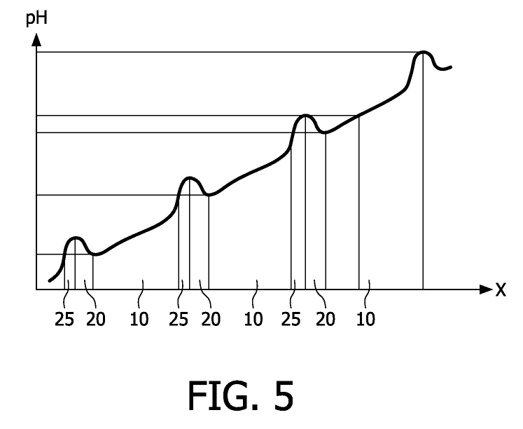

FIG. 4 shows a very schematic diagram of the pH-gradient along the separation direction (which is indicated with an “x”) according to a fourth embodiment of the present invention, FIG. 5 shows a very schematic diagram of the pH-gradient along the separation direction (which is indicated with an “x”) according to a fifth embodiment of the present invention.

In the embodiments of FIGS. 4 to 5, the pH-profile is identical, however, in FIG. 4 the separation direction is from left to right whereas in FIG. 5 it is from right to left, i.e. in the opposite direction.

In FIGS. 4 and 5, too it can be clearly seen that along the separation direction, there are consecutively provided a separation region 10, a pH-sink region 20 and a transition region 25, after that the next separation region 10 follows. However, in the embodiment of FIG. 4, the length of the regions with no or essentially no biomolecules (i.e. the regions 20 and 25) is much larger as compared to FIG. 5, which shows that simply by changing the separation direction it is possible within the present invention to alter the separation conditions to a great extent.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A device for use in separation, especially for isoelectric focusing comprising a multitude of regions which are provided adjacent to each other along a separation direction, whereby the device comprises at least a pH sink region where the pH value is constant or has a curve with a slope different in sign compared to at least one adjacent region at which the pH value is increasing or decreasing.

2. The device according to claim 1, whereby the device comprises a sequence of regions whereby a pH-sink region is followed by a separation region, whereby a separation region especially means and/or includes a region in which after the separation biomolecules may be present.

3. The device according to claim 1, whereby the device comprises a sequence of regions whereby a pH-sink region is followed by a transition region which is then followed by separation region, whereby a transition region in the sense of the present invention especially means and/or includes a region which is provided in separation direction immediately after a pH-sink region and which is after the separation essentially free of analytes.

4. The device according to claim 1, whereby the length of the pH sink region is ≧5% and ≦100% of the average of the two adjacent separation regions.

5. The device according to claim 1, whereby the difference in pH (highest minus lowest pH increasing or decreasing gradient) in each single separation region is ≧0.05 and ≦4.0.

6. The device according to claim 1, whereby the device comprises at least a starting region which is provided (in terms of the separation direction) prior to both the pH sink region(s) and the separation region(s).

7. The device according to claim 1, whereby the regions are provided within a substrate material comprising a polyacrylic material made out of the polymerization of at least one acrylic monomer and at least one polyfunctional acrylic monomer.

8. A device according to claim 1, whereby the polyfunctional acrylic monomer comprises at least one pH setting monomer.

9. A device according to claim 1 whereby the device furthermore comprises an automated analyzer and a multitude of pH sink regions, whereby the width of the pH sink regions are adapted to the shape of automated analyzer.

10. A system incorporating a device according to claim 1 and being used in one or more of the following applications:
biosensors used for molecular diagnostics
rapid and sensitive detection of proteins and nucleic acids in complex biological mixtures such as e.g. blood or saliva
high throughput screening devices for chemistry, pharmaceuticals or molecular biology
testing devices e.g. for DNA or proteins e.g. in criminology, for on-site testing (in a hospital), for diagnostics in centralized laboratories or in scientific research
tools for DNA or protein diagnostics for cardiology, infectious disease and oncology, food, and environmental diagnostics
tools for combinatorial chemistry analysis devices.
